(19) United States
(12) Patent Application Publication
(10) Pub. No.: US 2026/0093287 A1
(43) Pub. Date: Apr. 2, 2026

(54) Electronic Devices with Display Trim Structures

(71) Applicant: Apple Inc., Cupertino, CA (US)

(72) Inventors: James A. Stryker, Campbell, CA (US); Kevin M. Robinson, Sunnyvale, CA (US); James E. Wright, San Jose, CA (US)

(21) Appl. No.: 19/272,871

(22) Filed: Jul. 17, 2025

Related U.S. Application Data
(60) Provisional application No. 63/700,283, filed on Sep. 27, 2024.

(51) Int. Cl. G06F 1/16

(52) U.S. Cl. CPC G06F 1/1656; G06F 1/1652

(57) ABSTRACT

A foldable electronic device may include a flexible display panel surrounded by a display trim. The display trim may include first and second materials with different amounts of stiffness. In some arrangements, the first and second materials may be co-molded polymers that form a continuous loop around the display. The second material may be stiffer than the first material and may have a reduced thickness along the bendable region of the display panel to accommodate bending while protecting the more fragile portions of the display panel. The stiffer material may bring the effective neutral axis of the display trim down so that it aligns with the display panel in the bendable region. In some arrangements, the display trim may include a separate stiff member such as a metal insert, a fiberglass insert, a carbon fiber insert, or other stiff member along the bendable region of the display panel.

This application claims the benefit of U.S. provisional patent application No. 63/700,283, filed September 27, 2024, which is hereby incorporated by reference herein in its entirety.

### FIELD

This relates generally to electronic devices and, more particularly, to electronic devices with displays.

### BACKGROUND

Electronic devices often have displays. Portability may be a concern for some devices, which tends to limit available real estate for displays.

### SUMMARY

An electronic device may be provided with a foldable housing that allows the device to fold and unfold about a bend axis. A flexible display may be mounted in the foldable housing. The flexible display may have an array of pixels forming a display panel. The display panel may be configured to bend along the bend axis as the device is folded.

A display trim may wrap around the edges of the display panel and may form a seal between the display panel and the foldable housing. The display trim may protect the edge of the display panel as well as any components that are exposed in the gap between the display panel and the housing. The display trim may extend continuously around the periphery of the display panel, including both the bendable portions of the display and the non-bending portions of the display. The display trim may include first and second materials with different amounts of stiffness. In some arrangements, the first and second materials may be co-molded polymers that form a continuous loop around the display. The second material may be stiffer than the first material and may have a reduced thickness along the bendable region of the display panel to accommodate bending while protecting the more fragile portions of the display panel. The first material may cover the second material and may provide a uniform exterior appearance around the periphery of the display. The stiffer material may also serve to lower the effective neutral axis of the display trim in the bend region so that it aligns as desired with the display panel, despite the main portion of the trim being located above the display. This allows the display trim to follow (e.g., conform to) the curvature of the display panel during folding and unfolding. In some arrangements, the stiffer material may lower the effective neutral axis of the trim to be slightly below the neutral axis of the display panel, which may allow the seal around the display to always be slightly pre-loaded into the display.

In some arrangements, the display trim may include a separate stiff member such as a metal insert, a fiberglass insert, a carbon fiber insert, or other stiff member along the bendable regions of the display panel. The stiff member may bridge a gap in the second material of the display trim, or the stiff member may be formed from fibers that are laid directly into the first material of the display trim.

### BRIEF DESCRIPTION OF THE DRAWINGS

FIG. 1 is a schematic diagram of an illustrative electronic device in accordance with some embodiments.

FIG. 2 is a perspective view of an illustrative electronic device with a display surrounded by a display trim in accordance with some embodiments.

FIG. 3 is a side view of an illustrative electronic device in accordance with some embodiments.

FIG. 4 is a side view of an illustrative electronic device having a display trim formed from first and second materials in a non-bending region of the display in accordance with some embodiments.

FIG. 5 is a side view of an illustrative electronic device having a display trim formed from first and second materials in a bending region of the display in accordance with some embodiments.

FIG. 6 is a side view of an illustrative electronic device showing how a stiff material in a display trim may have a reduced thickness in a bending region of the display in accordance with some embodiments.

FIG. 7 is a side view of an illustrative electronic device showing how a stiff material in a display trim may be attached to an inserted stiff member in a bending region of the display in accordance with some embodiments.

FIG. 8 is an exploded perspective view of the display trim of FIG. 7 showing how first and second stiff members in a bending region of the display may respectively bridge first and second gaps in a stiff material of a display trim in accordance with some embodiments.

FIG. 9 is a side view of an illustrative electronic device showing how a stiff member may be located in a soft material in a display trim in a bending region of the display in accordance with some embodiments.

FIG. 10 is a side view of an illustrative electronic device showing how a housing trim may be located between a housing sidewall and a display in accordance with some embodiments.

FIG. 11 is a side view of an illustrative electronic device showing how a housing trim may form a housing sidewall in accordance with some embodiments.

FIG. 12 is a side view of an illustrative electronic device showing how a housing trim may be mounted to a display support layer and surrounded by an outer housing sidewall in accordance with some embodiments.

### DETAILED DESCRIPTION

Electronic devices may be provided with displays. Displays may be used for displaying images for users. Displays may be formed from arrays of light-emitting diode pixels or other pixels. For example, a device may have an organic light-emitting diode display or a display formed from an array of micro-light-emitting diodes (e.g., diodes formed from crystalline semiconductor dies).

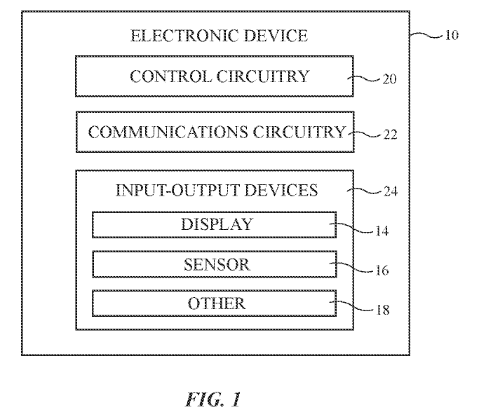

A schematic diagram of an illustrative electronic device having a display is shown in FIG. 1. Device 10 may be a cellular telephone, tablet computer, laptop computer, wristwatch device or other wearable device, a television, a stand-alone computer display or other monitor, a computer display with an embedded computer (e.g., a desktop computer), a system embedded in a vehicle, kiosk, or other embedded electronic device, a media player, or other electronic equipment. Configurations in which device 10 is a cellular telephone, tablet computer, or other portable electronic device may sometimes be described herein as an example. This is illustrative. Device 10 may, in general, be any suitable electronic device with a display.

Device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, control circuitry 20 may use a display and other output devices in providing a user with visual output and other output.

To support communications between device 10 and external equipment, control circuitry 20 may communicate using communications circuitry 22. Circuitry 22 may include antennas, radio-frequency transceiver circuitry (wireless transceiver circuitry), and other wireless communications circuitry and/or wired communications circuitry. Circuitry 22, which may sometimes be referred to as control circuitry and/or control and communications circuitry, may support bidirectional wireless communications between device 10 and external equipment over a wireless link (e.g., circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link). Wireless communications may, for example, be supported over a Bluetooth® link, a WiFi® link, a wireless link operating at a frequency between 6 GHz and 300 GHz, a 60 GHz link, or other millimeter wave link, cellular telephone link, wireless local area network link, personal area network communications link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as devices 24. Input-output devices 24 may be used in gathering user input, in gathering information on the environment surrounding the user, and/or in providing a user with output. Devices 24 may include one or more displays such as display 14. Display 14 may be an organic light-emitting diode display, a liquid crystal display, an electrophoretic display, an electrowetting display, a plasma display, a microelectromechanical systems display, a display having a pixel array formed from crystalline semiconductor light-emitting diode dies (sometimes referred to as microLEDs), and/or other display. Configurations in which display 14 is an organic light-emitting diode display or microLED display are sometimes described herein as an example.

Display 14 may have an array of pixels configured to display images for a user. The pixels may be formed as part of a display panel that is bendable. This allows device 10 to be folded and unfolded about a bend axis. For example, a flexible (bendable) display in device 10 may be folded so that device 10 may be placed in a compact shape for storage and may be unfolded when it is desired to view images on the display.

Sensors 16 in input-output devices 24 may include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into display 14, a two-dimensional capacitive touch sensor overlapping display 14, and/or a touch sensor that forms a button, trackpad, or other input device not associated with a display), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, and/or other sensors. In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

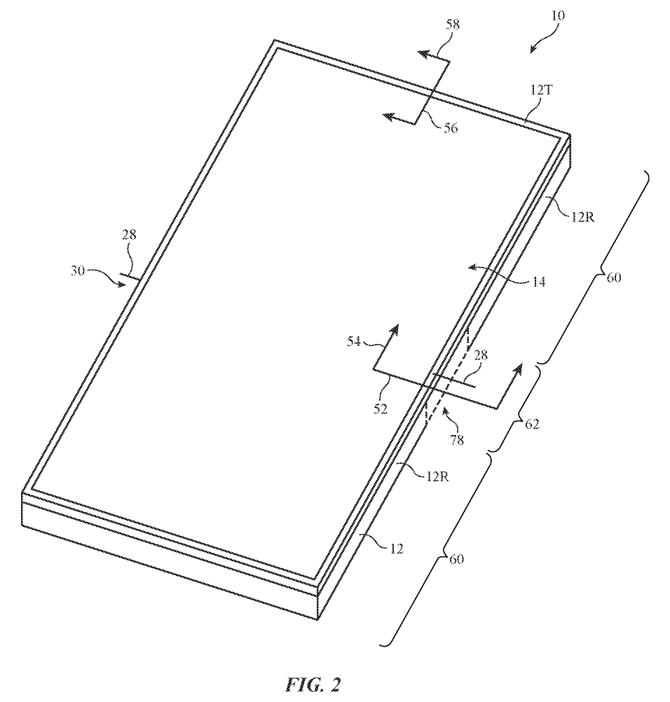

FIG. 2 is a perspective view of electronic device 10 in an illustrative configuration in which device 10 is a portable electronic device such as a cellular telephone or tablet computer. As shown in FIG. 2, device 10 may have a display such as display 14. Display 14 may cover some or all of the front face of device 10. Touch sensor circuitry such as two-dimensional capacitive touch sensor circuitry may be incorporated into display 14.

Display 14 may be mounted in housing 12. Housing 12 may form front and rear housing walls, sidewall structures, and/or internal supporting structures (e.g., a frame, an optional midplate member, etc.) for device 10. Glass structures, transparent polymer structures, and/or other transparent structures that cover display 14 and other portions of device 10 may provide structural support for device 10 and may sometimes be referred to as housing structures. For example, a transparent housing portion such as a glass or polymer housing structure that covers and protects a pixel array in display 14 may serve as a display cover layer for the pixel array while also serving as a housing wall on the front face of device 10. In configurations in which a display cover layer is formed from glass, the display cover layer may sometimes be referred to as a display cover glass or display cover glass layer. The portions of housing 12 on the sidewalls and rear wall of device 10 may be formed from glass or other transparent structures and/or opaque structures. Sidewalls and rear wall structures may be formed as extensions to the front portion of housing 12 (e.g., as integral portions of the display cover layer) and/or may include separate housing wall structures.

Device 10 may be a foldable electronic device that folds along one or more bend axes such as bend axis 28. In the example of FIG. 2, device 10 includes first and second portions 60 joined by bendable portion 62. Portions 60 of device 10 (e.g., portions 60 of display 14 and housing 12, sometimes referred to as the non-bending regions of device 10) may rotate relative to one another about axis 28. As one portion 60 rotates relative to another portion 60 (e.g., during folding and unfolding of device 10), bendable portion 62 of display 14 may bend and flex (e.g., while portions 60 remain flat).

Housing 12 may have flexible structures (e.g., bendable housing wall structures) and/or hinge structures such as hinge 30. Hinge 30 may have a hinge axis aligned with device bend axis 28. Hinge 30 and/or flexible housing structures that overlap bend axis 28 may allow housing 12 to bend about bend axis 28. For example, portion 60 of housing 12 may be located on one side of bend axis 28 and another portion 60 of housing 12 may be located on the opposing side of bend axis 28. Portions 60 of housing 12 may be coupled by hinge 30 for rotational motion about axis 28.

Housing 12 may include rear housing wall 12R and display trim 12T. Rear housing wall 12R may form a rear face of device 10. If desired, rear housing wall 12R may extend continuously across bendable region 62 of device 10, or rear housing wall 12R may have a gap ion region 62 such as gap 78 that overlaps and extends parallel to bend axis 28.

Display trim 12T may extend around the periphery of display 14 and may be used to seal display 14 to housing 12. If desired, display trim 12T may form a continuous loop without breaks around display 14. To accommodate bending in region 62 while providing sufficient display protection, display trim 12T may be formed from one or more different types of materials. For example, in an illustrative configuration, display trim 12T may include first and second materials such as a stiff material covered by a soft material. The stiff and soft materials may extend continuously around the perimeter of display 14. The stiff material may have a reduced thickness in bend region 62 and may be positioned such that the effective neutral axis of display trim 12T in bend region 62 is aligned as desired with the effective neutral axis of display 14 in bend region 62. This may ensure that display trim 12T bends with and matches the curvature of display 14 in region 62 while also allowing sealing between the display 14 and housing 12. In some arrangements, the stiff material in bend region 62 may lower the effective neutral axis of trim 12T to be slightly below the neutral axis of display panel 14P, which may allow the seal around display 14 to always be slightly pre-loaded into display 14, if desired. The stiff material in bend region 62 may have sufficient strength to protect the edges of display 14 in bend region 62, while the reduced thickness of the stiff material in this region allows display trim 12T to bend and flex as device 10 is folded and unfolded. The soft material may provide trim 12T with a uniform exterior appearance around the periphery of display 14. If desired, the soft and stiff materials may be co-molded polymers (e.g., a polycarbonate material or other stiff polymer co-molded with silicone or other soft polymer).

In another illustrative configuration, display trim 12T may include a rigid material covered by a soft material in regions 60, whereas bend region 62 may include a separate stiff member (e.g., a fiberglass insert, a carbon fiber insert, a metal insert, and/or any other suitable stiff member) that is attached to the rigid material or the soft material of regions 60. If desired, fibers (e.g., glass fibers, carbon fibers, etc.) in region 62 may be laid directly into a polymer material that forms trim 12T. The fibers may be located only in bend region 62 or may extend around the entire periphery of display 14. The fibers may extend perpendicular to axis 28, if desired, to provide additional protection to the edges of display 14.

Rigid materials in display trim 12T may include rigid polymers (e.g., polycarbonate, etc.), fiber-reinforced materials (e.g., carbon fiber, fiberglass, etc.), composite materials, metal (e.g., steel, aluminum, etc.), and/or other suitable materials. Soft materials in display trim 12T may include soft polymers (e.g., elastomeric materials, polyurethane, silicone, etc.), fabric, and/or other suitable materials. Because trim 12T extends continuously around display 14 and is able to follow (e.g., conform to) the curvature of display 14 during folding and unfolding, display 14 may be sealed to display trim 12T using a seal that forms a continuous loop without breaks around the display (or, if desired, trim 12T may be molded directly to display 14 without using a separate seal). The seal may be located between display 14 and trim 12T and/or may be formed between trim 12T and other portions of housing 12 (e.g., an outer housing sidewall and/or a rear wall of housing 12).

As housing 12 is bent about bend axis 28, the flexibility of display 14 allows display 14 to bend about axis 28. In an illustrative configuration, housing 12 and display 14 may bend by 180^{o}. This allows display 14 to be folded back on itself (with first and second outwardly facing portions of display 14 facing each other). The ability to place device 10 in a folded configuration in this way may help make device 10 compact so that device 10 can be stored efficiently. When it is desired to view images on display 14, device 10 may be unfolded about axis 28 to place device 10 in the unfolded configuration of FIG. 2. This allows display 14 to lie flat and allows a user to view flat images on display 14. The ability to fold display 14 onto itself allows device 10 to exhibit an inwardly folding behavior. Display 14 may be sufficiently flexible to allow device 10 to be folded outwardly and/or inwardly.

Device 10 of FIG. 2 has a rectangular outline (rectangular periphery) with four corners. As shown in FIG. 2, a first pair of parallel edges (e.g., the left and right edges of device 10 in the example of FIG. 2) may be longer than a second pair of parallel edges (e.g., the upper and lower edges of device 10 of FIG. 2) that are oriented at right angles to the first pair of parallel edges. In this type of configuration, housing 12 is elongated along a longitudinal axis that is perpendicular to bend axis 28. Housing 12 may have other shapes, if desired (e.g., shapes in which housing 12 has a longitudinal axis that extends parallel to bend axis 28). With an arrangement of the type shown in FIG. 2, the length of device 10 along its longitudinal axis may be reduced by folding device 10 about axis 28.

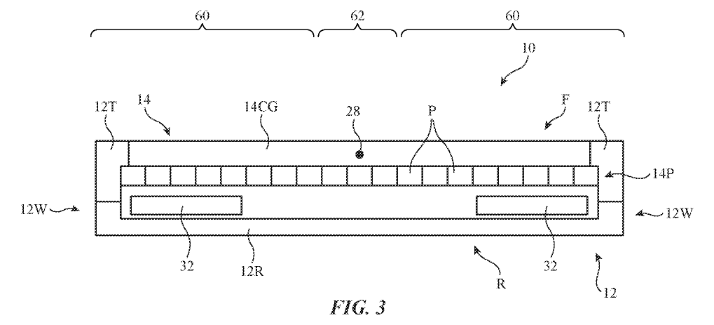

FIG. 3 is a cross-sectional side view of an illustrative foldable electronic device. Device 10 of FIG. 3 may bend about bend axis 28. Bend axis 28 may be aligned with display cover layer 14CG or other structures in device 10. For example, bend axis 28 may pass through a portion of display cover layer 14CG or may be located above or below layer 14CG.

As shown in FIG. 3, display 14 includes an array of pixels P forming display panel 14P under an inwardly facing surface of display cover layer 14CG. Display panel 14P may be, for example, a flexible organic light-emitting diode display or a microLED display in which light-emitting pixels are formed on a flexible substrate layer (e.g., a flexible layer of polyimide or a sheet of other flexible polymer). Flexible support layer(s) for display 14 may also be formed from flexible glass, flexible metal, and/or other flexible structures.

Display cover layer 14CG may be formed from polymer, glass, crystalline materials such as sapphire, other materials, and/or combinations of these materials. To enhance flexibility, a portion of layer 14CG that overlaps bend axis 28 may be locally thinned (e.g., this portion may be thinned relative to portions of layer 14CG that do not overlap bend axis 28). The thickness of layer 14CG (e.g., the non-thinned portions of layer 14CG) may be 50-200 microns, 70-150 microns, 100-200 microns, 100-600 microns, at least 100 microns, at least 200 microns, less than 600 microns, less than 400 microns, less than 250 microns, less than 150 microns, less than 100 microns, at least 50 microns, or other suitable thickness.

In the example of FIG. 3, housing 12 has a portion 12R on rear face R that forms a rear housing wall, has side portions forming sidewalls 12W, and has trim portions forming display trim 12T (e.g., a frame around display 14). If desired, some or all of rear housing wall 12R, sidewalls 12W, and display trim 12T may be formed from the same material and/or a unitary structure. For example, display trim 12T may also from sidewalls 12W, if desired. The rear housing wall 12R of housing 12 may form a support layer for components in device 10. Housing 12 may also have one or more interior supporting layers (e.g., frame structures such as an optional midplate, etc.). These interior supporting layers and the rear housing wall may have first and second portions that are coupled to opposing sides of a hinge that is aligned with bend axis 28 (see, e.g., hinge 30 of FIG. 2) or may be sufficiently flexible to bend around bend axis 28.

Electrical components 32 may be mounted in the interior of device 10 (e.g., between display 14 and the rear of housing 12. Components 32 may include circuitry of the type shown in FIG. 1 (e.g., control circuitry 20, communications circuitry 22, input-output devices 24, batteries, etc.). Display 14 may be mounted on front face F of device 10. When device 10 is folded about axis 28, display cover layer 14CG, display panel 14P, and the other structures of device 10 that overlap bend axis 28 may flex and bend to accommodate folding.

Trim 12T may extend partially or completely around the periphery of device 10. If desired, trim 12T may have a different construction in non-bending regions 60 of display 14 than in bending region 62 of display 14. In particular, non-bending regions 60 of display 14 may include first and second materials such as a stiff material that provides display protection and a flexible (e.g., soft) material that covers the stiff polymer and provides a uniform appearance on the exterior of trim 12T. The stiff and soft materials may be co-molded polymers or may be formed from other suitable materials. In bending region 62, the stiff material may have a reduced thickness to accommodate bending, or a separate stiff member may be inserted into trim 12T in bend region 62 to provide increased strength and display protection while still allowing display 14 to bend.

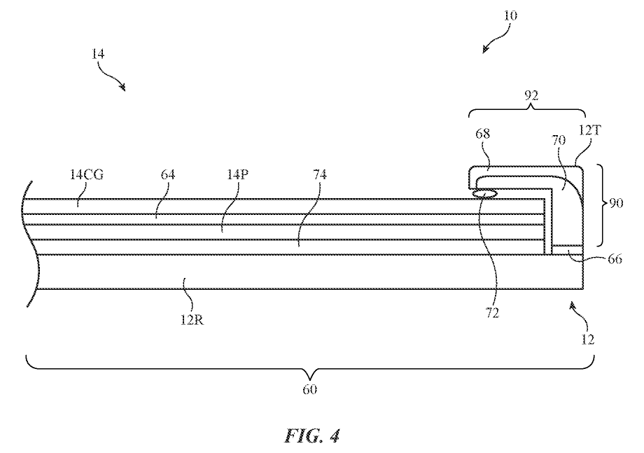

FIG. 4 is a side view of device 10 showing how display trim 12T may be configured in non-bending region 60 of display 14. The side view of FIG. 4 is taken along line 56 and viewed in direction 58 of FIG. 2. Display 14 may include display panel 14P. Display cover layer 14CG may overlap display panel 14P and may be attached to display panel 14P using adhesive such as adhesive 64. In non-bending regions 60, display panel 14P may be supported by a backing member such as backing member 74. Backing member 74 may be formed from metal, polymer, glass, and/or other suitable materials.

Display trim 12T may wrap around the edges of display 14. If desired, display trim 12T may have first and second orthogonal portions such as first portion 90 and second portion 92. First portion 90 may form a sidewall around display 14, whereas portion 92 may form a lip that extends over the top surface of display 14. This is merely illustrative. If desired, trim 12T may include lip portion 92 without including sidewall portion 90, or trim 12T may include sidewall portion 90 without including lip portion 92. Trim 12T may be sealed to the display using seal 72. In some arrangements, seal 72 may be a bead of sealant that extends partially or entirely around display 14 (e.g., continuously without breaks, if desired). In other arrangements, seal 72 may be created by applying pressure to an elastomer in contact with display 14. Seal 72 may, for example, be formed from a portion of trim 12T (e.g., a soft polymer in trim 12T such as material 68). Arrangements in which trim 12T is molded directly to display 14 and seal 72 is omitted may also be used.

In non-bending region 60 of display 14, trim 12T may be formed from one or more materials such as first material 68 and second material 70. Second material 70 may be stiffer than first material 68 (e.g., material 70 may have a higher modulus of elasticity than material 68), so first material 68 may sometimes be referred to as soft material 68 and second material 70 may sometimes be referred to as stiff material 70. Stiff material 70 may be formed from a stiff polymer (e.g., polycarbonate or other suitable polymer), metal (e.g., steel, aluminum, sheet metal, titanium, and/or any other suitable metal), and/or other rigid materials. Soft material 68 may be formed from a soft polymer (e.g., elastomer, polyurethane, silicone, etc.), fabric, and/or other suitable materials. In some arrangements, soft material 68 and stiff material 70 may be co-molded polymers. In other arrangements, stiff material 70 may be a non-polymer material such as metal and soft material 68 may be overmolded or insert molded around stiff material 70. Trim 12T may be attached to rear housing wall 12R using an adhesive such as adhesive 66, or trim 12T may include a material that also forms rear housing wall 12R (in which case adhesive 66 may be omitted).

As shown in FIG. 4, rigid material 70 may be interposed between display 14 and soft material 68. Rigid material 70 may serve to protect the edges of display 14 from damage during an impact event (e.g., an object being dropped on or otherwise impacting device 10, a drop event in which device 10 is dropped, etc.). Soft material 68 may partially or fully cover stiff material 70 to provide a uniform appearance on the exterior of device 10. For example, soft material 68 may form a continuous loop (e.g., without breaks) around the periphery of display 14, such that trim 12T has a uniform and interrupted appearance around display 14 in both non-bending regions 60 and bending region 62.

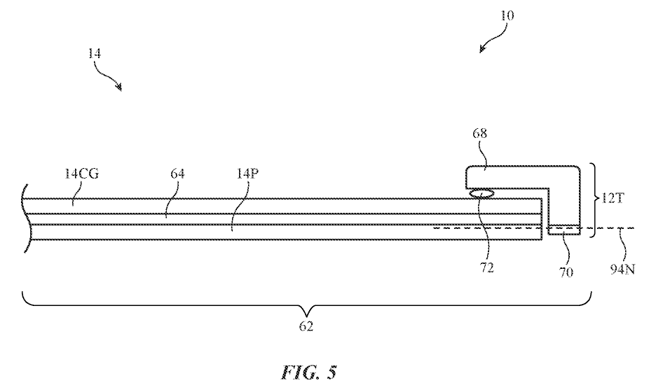

FIG. 5 is a side view of device 10 showing how display trim 12T may be configured in bending region 62 of display 14. The side view of FIG. 5 is taken along line 52 and viewed in direction 54 of FIG. 2. In bending regions 62, some layers such in display 14 may be omitted or modified to allow display 14 to bend. For example, backing member 74 may be omitted in bend region 62 (as shown in the example of FIG. 5), or backing member 74 may have a reduced thickness in bend region 62. Cover layer 14CG may have a reduced thickness in region 62 relative to regions 60, if desired.

To allow display trim 12T to bend in region 62, the thickness of rigid material 70 in bend region 62 may be reduced relative to the thickness of rigid material 70 in non-bending regions 60. If desired, the thickness of soft material 68 in bend region 62 may be increased relative to the thickness of soft material 68 in non-bending regions 60 to maintain a uniform overall thickness of display trim 12T around display 14, or the overall thickness of display trim 12T may also be reduced in bend region 62 relative to non-bending regions 60. In the example of FIG. 5, soft material 68 has an increased thickness in bend region 62 relative to soft material 68 in non-bending region 60 of FIG. 4.

In addition to reducing the thickness of stiff material 70 in bend region 62, the position of stiff material 70 relative to display panel 14P may also be modified in region 62 when compared with its position in non-bending regions 60 of FIG. 4. In particular, stiff material 70 in bend region 62 may be positioned to lower the effective neutral axis 94N of trim 12T to be closer to the effective neutral axis of display panel 14P. In particular, the effective neutral axis 94N of trim 12T may be lower along bendable region 62 of display 14 relative to the effective neutral axis of trim 12T along non-bending regions 60 of display 14.

In some arrangements, stiff material 70 may lower the effective neutral axis 94N of trim 12T in region 62 to be at the same level as the effective neutral axis of display panel 14P. In other arrangements, stiff material 70 may lower the effective neutral axis 94N of trim 12T in region 62 to be slightly below the effective neutral axis of display panel 14P, which may allow the seal around display 14 to always be slightly pre-loaded into display 14. By placing stiff material 70 such that the effective neutral axis 94N of trim 12T is aligned with (e.g., at the same level or slightly below) the effective neutral axis of display panel 14P, trim 12T (including soft material 68) may follow the curvature of display 14 during folding an unfolding (e.g., the curvature of trim 12T may conform to the curvature of display 14 during bending).

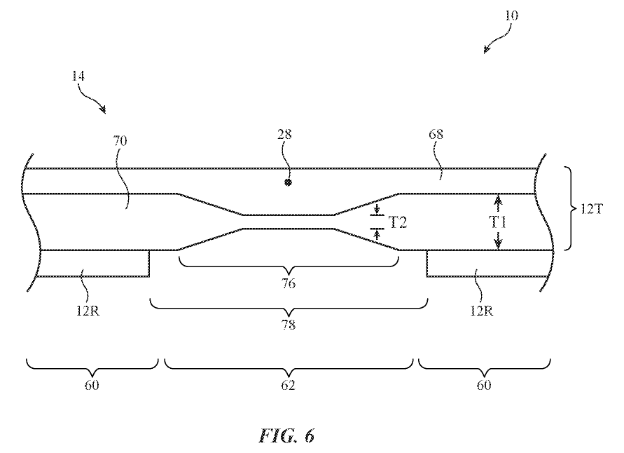

FIG. 6 is a side view of device 10 when viewed along bend axis 28. As shown in FIG. 6, display trim 12T may extend around the periphery of display 14 in both non-bending regions 60 and bend region 62. In non-bending regions 60, trim 12T may include soft material 68 molded over or co-molded with rigid material 70. Rigid material 70 may have a first thickness T1 in non-bending regions 60. If desired, rear housing panel 12P may support display 14 in non-bending regions 60.

To accommodate bending in region 62, stiff material 70 may have a reduced thickness portion 76 with thickness T2 (less than T1) in region 62. Stiff material 70 may taper gradually from thickness T1 in non-bending regions 60 to thickness T2 in bend region 62, or stiff material 70 may have a more abrupt change in thickness at portion 76. If desired, rear housing panel 12P may have a gap such as gap 78 that overlaps and extends parallel bend axis 28 to facilitate bending in region 62.

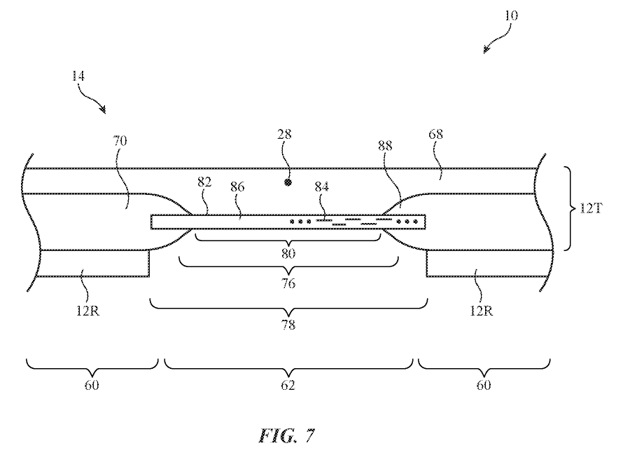

If desired, a separate stiff member that is optimized for bending in bend region 62 may be used in place of stiff material 70 in region 62. This type of arrangement is illustrated in FIG. 7. As shown in FIG. 7, trim 12T may include stiff member 82 in bend region 62. Stiff member 82 may be formed from fiberglass, carbon fiber, aramid, nitinol, and/or other suitable stiff materials that provide sufficient protection for display 14 (which tends to be more fragile in bend region 62) while also being bendable. In some arrangements, stiff member 82 (sometimes referred to as a stiffener, an insert, a fiberglass insert, etc.) may include fibers 84 (e.g., carbon fibers, glass fibers, etc.) in a resin such as resin 86 (e.g., a polymer resin). Fibers 84 may be oriented perpendicular to bend axis 28 to provide additional display protection in bend region 62, if desired.

As shown in FIG. 7, stiff material 70 of trim 12T may have a gap such as gap 80 in bend region 62. Stiff member 82 may be located in gap 80 and may have a first end attached to stiff material 70 in a first non-bending region 60 and a second opposing end attached to stiff material 70 in a second non-bending region 60. If desired, stiff material 70 may have tapered edges 88 with gradually reduced thickness approaching bend region 62 where stiff material 70 is bonded to stiff member 82.

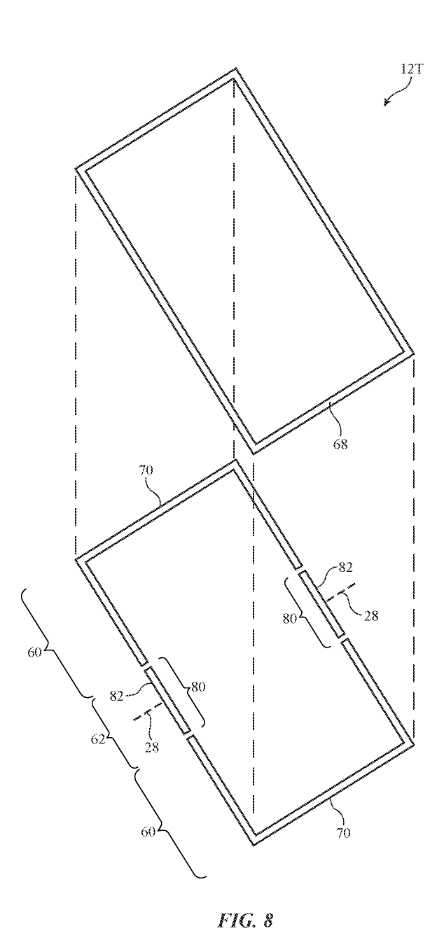

An exploded perspective view of display trim 12T of FIG. 7 is shown in FIG. 8. As shown in FIG. 8, display trim 12T may include soft material 68, stiff material 70, and first and second stiff members 82. Soft material 68 may form a continuous loop (e.g., without breaks, if desired) around display 14. In other words, soft material 68 may wrap around the edges of display 14 in both non-bending regions 60 and bending region 62. Rigid material 70 include a first portion (e.g., a first U-shaped portion) in a first of non-bending regions 60 and a second portion (e.g., a second U-shaped portion) in a second of non-bending regions 60. The two portions of rigid material 70 may be separated by gap 80 in bend region 62. In bend region 62, stiff member 82 may be located within gap 80 and may be bonded to stiff material 70. A first stiff member 82 may be located in a first gap 80 on one side of display 14, and a second stiff member 82 may be located in a second gap 80 on the opposing side of display 14.

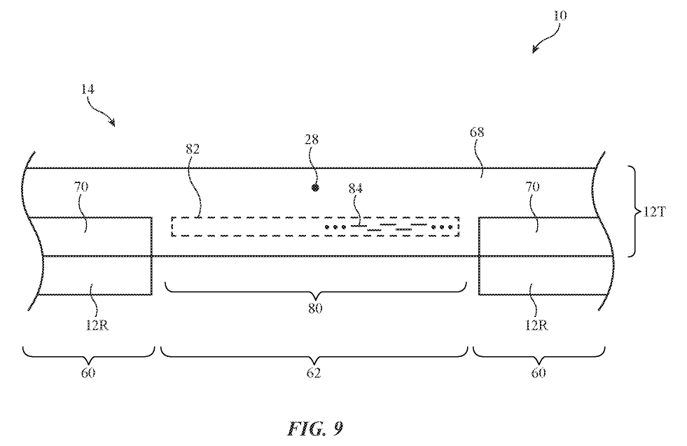

If desired, stiff member 82 may be bonded to soft material 68 instead of stiff material 70, or the fibers of stiff member 82 may be laid directly into the polymer material that forms soft material 68 or stiff material 70. In the example of FIG. 9, stiff member 82 has been bonded to, inserted in, or otherwise formed in soft material 68. With this type of configuration, gap 80 is still present in stiff material 70 in bend region 62. Gap 80 is bridged by soft material 68 and stiff member 82. Stiff member 82 may be a separate fiberglass insert, a carbon fiber insert, a metal insert, or other suitable stiff member, or stiff member 82 may be formed from fibers 84 that are laid directly into polymer 68 in region 62. Fibers 84 may extend perpendicular to bend axis 28 to provide additional protection for display 14, if desired.

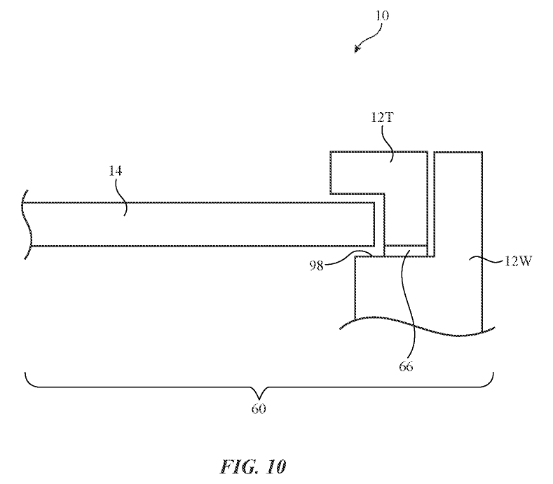

FIGS. 10, 11, and 12 show different trim configurations for trim 12T of housing 12. In the example of FIG. 10, trim 12T is located between display 14 and outer housing sidewall 12W. Housing sidewall 12W may have a ledge such as ledge 98 that forms a shelf for display 14 and trim 12T. Trim 12T may be mounted to ledge 98 using an adhesive such as adhesive 66.

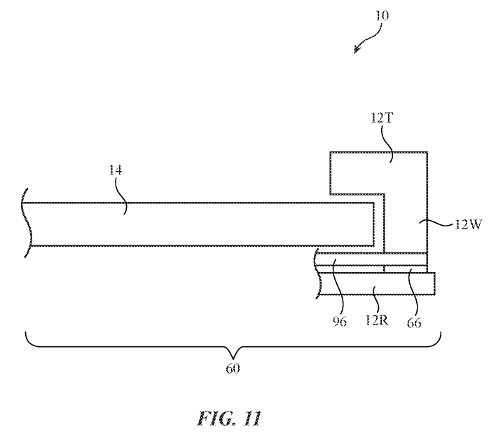

In the example of FIG. 11, trim 12T forms a display trim and also forms at least an upper portion of outer housing sidewall 12W. With this type of arrangement, housing 12 may appear to be a monolithic rectangle from the exterior, while being able to bend in region 62 due to the presence of stiff member 82 (FIGS. 7, 8, and 9) or stiff material 70 (FIGS. 5 and 6) in bend region 62. Additionally, the more delicate parts of display 14 in bend region 62 may be protected by stiff member 82 or stiff material 70 in bend region 62.

In the example of FIG. 11, display trim 12T is mounted to a display support layer such as display support layer 96. Display support layer 96 may be a midplate, a backplate, or other support structure that supports display 14. Display support layer 96 may be formed from metal, polymer, or other suitable materials. Display support layer 96 may span across bend axis 28 or may be separated into first and second portions that respectively support first and second portions 60 of display 14. Display support layer 96 may be mounted to rear housing wall 12R using a seal such as seal 66 (e.g., adhesive, polymer, elastomer, molded material, a bead of sealant, etc.).

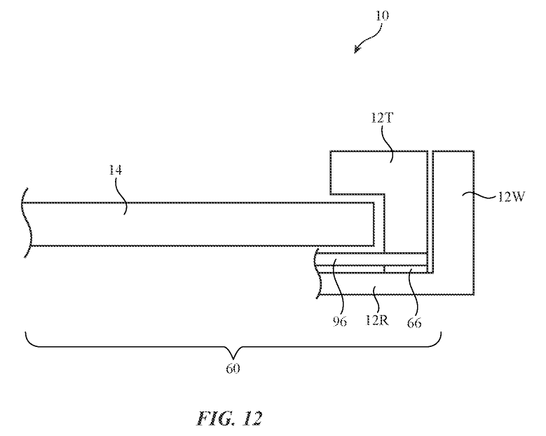

In the example of FIG. 12, display trim 12T is mounted to display support layer 96 and is surrounded by an outer housing such as outer housing sidewall 12W and rear housing wall 12R. Display support layer 96 may be mounted to the outer housing such as rear housing wall 12R using seal 66. Outer housing sidewall 12W and rear housing wall 12R may provide housing 12 with a monolithic appearance from the exterior, while allowing display 14 and trim 12T to bend in region 62 due to the presence of stiff member 82 (FIGS. 7, 8, and 9) or stiff material 70 (FIGS. 5 and 6) in bend region 62. Additionally, the more delicate parts of display 14 in bend region 62 may be protected by stiff member 82 or stiff material 70 in bend region 62.

Device 10 may be operated in a system that uses personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. An electronic device, comprising:
a flexible display panel having first and second portions joined by a bendable portion; and
a display trim surrounding the flexible display panel, wherein the display trim comprises first and second materials, wherein the second material is stiffer than the first material and is located along the bendable portion of the flexible display panel, and wherein an effective neutral axis of the display trim along the bendable portion of the flexible display panel is lower than the effective neutral axis of the display trim along the first and second portions of the flexible display panel.

2. The electronic device defined in claim 1 wherein a thickness of the second material is reduced along the bendable portion of the flexible display panel relative to other portions of the second material.

3. The electronic device defined in claim 2 wherein the first and second materials form a continuous loop around the flexible display panel.

4. The electronic device defined in claim 3 wherein the first and second materials comprise co-molded polymers.

5. The electronic device defined in claim 1 wherein the second material has first and second gaps located on opposing sides of the flexible display panel along the bendable portion, the display trim further comprising a first stiff member that bridges the first gap and a second stiff member that bridges the second gap.

6. The electronic device defined in claim 5 wherein the first and second stiff members are selected from the group consisting of: a fiberglass insert, a carbon fiber insert, and a metal insert.

7. The electronic device defined in claim 1 further comprising a seal that seals the flexible display panel to the display trim, wherein the seal forms a continuous loop around the flexible display panel.

88. The electronic device defined in claim 1 further comprising an outer housing sidewall with a ledge, wherein the display trim is interposed between the flexible display panel and the housing sidewall and is mounted to the ledge.

9. The electronic device defined in claim 1 wherein the display trim forms an upper portion of an outer housing sidewall.

10. The electronic device defined in claim 1 further comprising:
a display support layer that supports the flexible display panel, wherein the display trim is mounted to the display support layer; and
an outer housing that surrounds the display trim, wherein the display support layer is mounted to the outer housing.

11. The electronic device defined in claim 1 wherein the first material is selected from the group consisting of: elastomer, silicone, and polyurethane, and wherein the second material is selected from the group consisting of: polycarbonate and metal.

12. A foldable display, comprising:
a flexible display panel having first and second portions joined by a bendable portion, wherein the first portion is configured to rotate relative to the second portion about a bend axis that overlaps the bendable portion; and
a display trim that wraps around the flexible display panel, wherein the display trim comprises first and second materials, wherein the second material is stiffer than the first material, and wherein the second material has a first thickness along the first and second portions and a second thickness that is less than the first thickness along the bendable portion.

13. The foldable display defined in claim 12 wherein the first and second materials comprise co-molded polymers that form a continuous loop around the flexible display panel.

14. The foldable display defined in claim 12 wherein an effective neutral axis of the display trim along the bendable portion of the flexible display panel is lower than the effective neutral axis of the display trim along the first and second portions of the flexible display panel.

15. A foldable electronic device, comprising:
a flexible display panel configured to fold along a bend axis; and
a display trim that wraps around the flexible display panel, wherein the display trim comprises:
a first material that extends around a periphery of the flexible display panel;
a second material that is stiffer than the first material and that extends partially around the periphery of the flexible display panel, wherein the second material has first and second gaps aligned with the bend axis; and
first and second stiff members that respectively bridge the first and second gaps.

16. The foldable electronic device defined in claim 15 wherein the first and second stiff members are selected from the group consisting of: a fiberglass insert, a carbon fiber insert, and a metal insert.

17. The foldable electronic device defined in claim 15 wherein the first material is selected from the group consisting of: elastomer, silicone, and polyurethane.

18. The foldable electronic device defined in claim 15 wherein the second material is selected from the group consisting of: polycarbonate and metal.

19. The foldable electronic device defined in claim 15 wherein the first and second stiff members comprise fibers that are oriented perpendicular to the bend axis.

20. The foldable electronic device defined in claim 19 wherein the fibers are laid into the first material.
